(19) United States
(12) Patent Application Publication
(10) Pub. No.: US 2026/0086626 A1
(43) Pub. Date: Mar. 26, 2026

(54) AUGMENTED REALITY SYSTEMS, DEVICES AND METHODS

(71) Applicant: ARTIFICIAL INTELLIGENCE CENTRE OF EXCELLENCE PTY LTD, Perth (AU)

(72) Inventor: Christopher James MARKOVIC, Perth (AU)

(73) Assignee: ARTIFICIAL INTELLIGENCE CENTRE OF EXCELLENCE PTY LTD, Perth, WA (AU)

(21) Appl. No.: 19/109,523

(22) PCT Filed: Aug. 14, 2023
(86) PCT No.: PCT/AU2023/050766

§ 371 Date: Mar. 6, 2025

(30) Foreign Application Priority Data
Aug. 14, 2022 (AU) 2022902303
Aug. 14, 2022 (AU) 2022902304
Aug. 14, 2022 (AU) 2022902305

(51) Int. Cl. G06F 3/01; G02B 27/01; G03H 1/00; G06V 10/141; G06V 20/20; G06V 40/10; G06V 40/20

(52) U.S. Cl. CPC G06F 3/011; G02B 27/0103; G02B 27/0172; G03H 1/0005; G06V 10/141; G06V 20/20; G06V 40/10; G06V 40/28; G02B 2027/0138; G02B 2027/0174

(57) ABSTRACT

One example of the present application discloses an augmented reality (AR) method and system which may connect a remote expert with a front line worker. A first video stream from a 2D camera at a first location where the remote expert is located is processed in real time to determine 3D coordinates of a hand of the remote expert. An AR model is mapped to the 3D coordinates of the hand of the remote expert and rendering in real time as a first AR image in a AR headset at a second location at which the front line worker is located. Further examples relate to an augmented lighting system and an augmented optics system.

### TECHNICAL FIELD

The present disclosure relates to augmented reality systems, devices and methods. The augmented reality system may be used to enable a remote expert at a first location to assist and guide a front liner worker in performing a task on site at a second location. For instance, the augmented reality system may be used to enable an experienced surgeon or medical expert to remotely guide a front line surgeon to perform surgery or another medical procedure.

### BACKGROUND

It is sometimes the case that a person present a first location where a task is to be performed may lack the expertise or experience to perform the task without guidance. For instance, a surgeon performing a new type of surgery at a first hospital may benefit from guidance from a more experienced surgeon is only available at a second hospital which is some distance away. Similarly, a worker in a factory may require assistance or training from a remote expert. These issues became particularly pressing during the covid-19 pandemic when travel was restricted, but may arise at any time due to restricted travel budgets, a trend toward remote working practices, responding to emergency events and collaboration across borders, especially where expertise in particular area is confined to a small number of individuals or a few cities in particular countries.

Augmented reality (AR) refers to a computing system which provides users with a view of the real world and supplements this view with text, images, video or insignia overlaid over the view of the real world to provide the user with an augmented experience. An AR headset is a AR device which is worn by the user and includes a screen through which the user can view the world. In the case of AR glasses, the screen may include one or more transparent eye pieces or lenses. AR images are overlaid onto the user's field of view by the screen. In some implementations the AR images may be produced by one or more LEDs positioned behind and projecting light onto the screen. In some examples, the AR images may be 3D images, such as holograms. Virtual reality (VR) refers to a computing system which completely cuts the user's vision off from the real world and replaces it with a virtual reality constructed by virtual images.

Systems such as the Apple Vision Pro may be considered to be a hybrid of VR and AR system. Instead of providing the user with a direct view of the real world through a transparent screen, the headset has a number of cameras which provide a real time 3D video stream of the real world which is displayed by the screen and AR images are overlaid on this view of the real world. In the context of this disclosure, such hybrid systems which show both the real world and overlaid AR images, are considered to be AR systems.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

A first aspect of the present disclosure provides a method of using augmented reality (AR) to connect a remote expert with a front line worker, the method comprising: receiving, by a processor, a first video stream from a 2D camera at a first location where the remote expert is located; processing the first video stream in real time, by a processor, to determine 3D coordinates of a hand of the remote expert; mapping, by a processor, an AR model to the 3D coordinates of the hand of the remote expert; and rendering the AR model in real time as a first AR image in a AR headset at a second location at which the front line worker is located, the second location being remote from the first location.

A second aspect of the present disclosure provides a remote expert computing device comprising a display, a 2D camera and processor and a computer readable storage medium storing instructions executable by the processor to: receive, by the processor from the 2D camera, a first video stream including a hand of the remote expert; process the first video stream in real time to determine 3D coordinates of the hand of the remote expert; and send the determined 3D coordinates of the hand of the remote expert to an AR headset of a front line worker.

A third aspect of the present disclosure provides an AR headset comprising a screen through which a front line worker can view the real world and AR images overlaid onto the view of the real world by the AR headset; a camera for capturing a field of view of the front line worker, a processor and computer readable storage medium storing instructions executable by the processor to: receive, in real time, 3D coordinates of a remote expert's hand; map, in real time, an AR model to the 3D coordinates of the remote expert's hand; and render the AR model in real time as a first AR image viewable by the wearer of the AR headset.

A fourth aspect of the present disclosure provides an augmented reality (AR) lighting system comprising: an AR headset; a light wave emission device for projecting light onto an area in front of the AR headset to illuminate a target subject; a communications module for receiving lighting control instructions from a remote user; a processor for controlling the light wave emission device in accordance with the lighting control instructions from the remote user.

A fifth aspect of the present disclosure provides an optics system for an augmented reality headset comprising: an optics device including a light guide and reflector for redirecting light from in front of and beneath the augmented reality headset into a camera of the augmented reality headset; and wherein the optics system further comprises an attachment part for attaching the optics system to the augmented reality headset, or wherein the optics system is integral with the augmented reality headset.

A sixth aspect of the present disclosure provides a method of performing surgery or a medical procedure comprising a front line medical worker wearing an AR headset, capturing a field of view of the front liner worker with a camera of the AR headset and transmitting a video stream of the field of view of the front line worker to a display on a computing device of a remote medical expert, the remote medical expert using the computing device to send directions and instructions for performing the surgery or medical procedure to the front line worker via the AR headset of the front line worker.

Further aspects and features of the present disclosure are provided in the following description and the appended claims.

### BRIEF DESCRIPTION OF THE DRAWINGS

Examples of the present disclosure will now be described, by way of non-limiting example only, with reference to the accompanying drawings, in which:

FIG. 1 is a schematic diagram showing an augmented reality system according to a first embodiment of the present disclosure;

FIG. 2 is a schematic diagram showing an augmented reality method according to a first embodiment of the present disclosure;

FIG. 3 is a schematic diagram showing a remote expert computing device according to a first embodiment of the present disclosure;

FIG. 4 is a schematic diagram showing an augmented reality (AR) headset according to a first embodiment of the present disclosure;

FIG. 5A is a schematic diagram showing a first part of an augmented reality method according to a first embodiment of the present disclosure;

FIG. 5B is a schematic diagram showing a first part of an augmented reality method according to a first embodiment of the present disclosure;

FIG. 5C shows a video stream and AR image on a display of a remote expert computing device according to an example of the present disclosure;

FIG. 5D shows a front liner worker, a patient and a view of the real word and overlaid AR image as seen through a screen of a AR headset worn by the front line worker, according to an example of the present disclosure;

FIG. 6 is a schematic diagram showing a method of determining 3D coordinates of a hand of a remote expert from a 2D image from a video stream of the remote expert according to an example of the present disclosure;

FIG. 7 is a schematic diagram showing a method of converting the 3D coordinates of a hand of a remote expert to the frame of reference of the field of view of the front line worker according to an example of the present disclosure;

FIG. 8A is a schematic diagram showing an augmented reality lighting system according to a second embodiment of the present disclosure;

FIG. 8B is a schematic diagram showing a method of operating of the augmented reality lighting system of FIG. 8A;

FIG. 9 is a perspective view of an AR headset together with an AR lighting system according to second embodiment of the present disclosure;

FIG. 10 is a schematic diagram showing an augmented reality lighting system according to a second embodiment of the present disclosure;

FIG. 11 is a schematic diagram showing a method of determining field depth of an image using an augmented reality lighting system according to a second embodiment of the present disclosure;

FIG. 12 is a schematic diagram showing a method of highlighting a visual feature of a target onto which light is projected by an augmented reality lighting system according to a second embodiment of the present disclosure;

FIG. 13 is a schematic diagram showing a further example of an augmented reality lighting system of the second embodiment of the present disclosure;

FIG. 14 is a schematic diagram showing an example of a server for use with the augmented reality lighting system of the second embodiment of the present disclosure;

FIG. 15 is a perspective view of an optics system for an augmented reality headset according to the third embodiment of the present disclosure;

FIG. 16 is a top down view of an augmented reality headset together with an optics system for the augmented reality headset according to the third embodiment of the present disclosure;

FIG. 17 is a side view of an augmented reality headset together with an optics system for the augmented reality headset according to the third embodiment of the present disclosure;

FIG. 18 is a front view of an augmented reality headset together with an optics system for the augmented reality headset according to the third embodiment of the present disclosure;

FIG. 19 is a schematic diagram showing a further example of an augmented reality method according to the present disclosure; and

FIG. 20 is a schematic diagram showing a further example of an augmented reality system according to the present disclosure.

### DESCRIPTION OF EMBODIMENTS

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The terms “includes” means includes but not limited to, the term “including” means including but not limited to. The term “based on” means based at least in part on. The term “number” means any natural number equal to or greater than one. The terms “a” and “an” are intended to denote at least one of a particular element.

In the context of this disclosure, the term “remote expert” refers to a person at a first location, while the term “front line worker” refers to a person at a second location where a task is to be carried out. The remote expert may have expertise or experience in a particular task, such as but not limited to a particular type of surgery, medical procedure, operation of a certain type of machinery, assembly or construction of a particular product etc.

The first location may be remote from the second location. The term remote means that the two individuals are not in the same physical space. As they are not in the same physical space, they may not be within direct eyesight of each other. For instance they may be in different rooms, different buildings, different cities, different areas of a country or in different countries. The first location at which the remote expert is situated may be referred to as the remote location. The second location at which the front line worker is situated may be referred to as the in-situ location. The remote expert may also be referred to as the remote collaborator or remote user. The front line worker may also be referred to as the person or user in-situ, the person on-site or the on-site user.

In the context of this disclosure, an augmented reality (AR) system refers to a computing system which overlays a view of the real world with virtual computer generated images. In the context of this disclosure, an augmented reality (AR) headset refers to a AR device including a screen worn over the eyes of the user which provides the user with a view of the real world and which overlays virtual computer generated images (referred to as AR images) over or onto the view of the real world. The screen may be a transparent screen through which the user views the real world. The AR images may be generate by an AR image generator of the AR headset. The AR image generator may for instance include one or more LEDs positioned behind the screen and configured to project light onto the screen. The AR images may in some examples include 3D images, which may for example be holograms.

An AR headset may provided with one or more cameras to capture a field of view of the front line worker and a communications module or interface to transmit a video stream of the field of view to a remote expert. The remote expert may see the field of view of the remote expert through a client device, such as the display of a computer monitor and may provide audio or typed instructions to the front line worker over the communication link. However, it can be difficult to give precise instructions for manual tasks using words or audio. In some cases, if the remote expert's client device has a touch screen, the remote expert may tap or draw on a location on the touch screen in order to highlight or mark an area and the highlighted or marked area may be shown as an AR image on the AR headset. However, they can only highlight an area on a 2D display and it can be difficult to express hand motions or other complicated 3D movements, especially for delicate and precise tasks such as surgery.

The remote expert may have their own AR headset and 3D cameras to capture the remote expert hand position and movements for transmission to the front line worker. However, this requires the remote expert to have access to complicated and expensive hardware and can cause latency issues when implemented in real time over distance, due to the large volume of data which needs to be transmitted by the remote expert's AR headset and 3D cameras.

Accordingly, a first embodiment of the present disclosure discussed below, provides a systems, methods and devices which may enable a remote expert using a simple device with a 2D camera to capture their hand movements and use their hand movements to control and move a 3D AR image on the front line worker's AR headset. A second embodiment of the present disclosure allows the remote expert at the first location to remotely control one or more lights associated with the AR headset which illuminate the field of view of the front line worker. A third embodiment of the present disclosure provides a device which allows the remote expert to view an area which is not directly in front of the front line worker. These and other features, aspects and advantages of the systems, methods and devices proposed by the present disclosure will become apparent from the following description of the three above mentioned embodiments.

### First Embodiment: AR Image Based on Remote Expert Hand Position

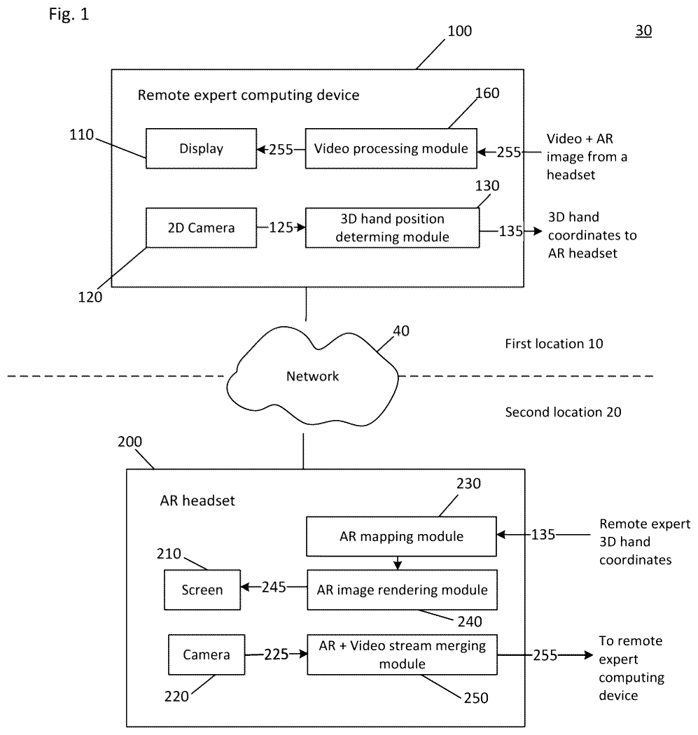

A first embodiment of the present disclosure relates to an augmented reality system and a method of using augmented reality to connect a remote expert with a front line worker. As shown in FIG. 1, the augmented reality (AR) system 30 comprises a remote expert computing device 100 and an augmented reality (AR) headset 200. The remote expert computing device 100 is at a first location 10 where the remote expert is situated, while the AR headset 200 is to be worn by the front line worker at a second location 20 where the task is to be carried out. The first location 10 is remote from the second location 20.

For example, the front line worker may be a person who is to perform surgery, or another medical procedure, on a patient at the second location. For instance, the front line worker may be a surgeon and the remote expert may be an experienced doctor or medical professional. In other examples, the front line worker may be an engineer, factory or construction worker, person responsible for operating a machine or driving a vehicle etc., while the remote expert may be a person with expert knowledge or experienced in such tasks.

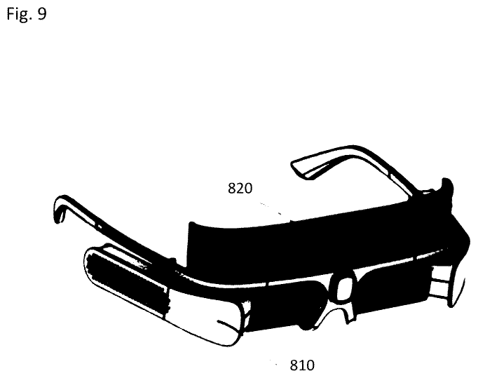

The AR headset 200 comprises a screen 210 through which the front line worker can view the real world. For example, the screen 210 may be a transparent screen and may include one or more eyepieces or lenses. The AR headset 200 further comprises one or more cameras 220 for capturing a field of view of the front line worker in real time. The one or more cameras 220 generate a real time video stream 225 of the field of view of the front line worker, which may be sent to the computing device 100 of the remote expert. An example AR headset, in the form of a pair of AR glasses 810, is shown in FIG. 9.

The remote expert computing device 100 may be any computing device such as a desk top computer, laptop computer, tablet computer or mobile phone etc. The remote expert computing device 100 includes a display 110 which displays a video stream of the field of view of the front line worker sent from the AR headset 200. The remote expert computing device 100 further includes a camera 120. The camera 120 is arranged to capture a video stream 125 of the remote expert including the remote expert's hands. The camera 120 may be a 2D camera, such as a web cam or a front facing camera of a tablet device.

The video stream from the camera 120 of the remote expert computing device 100 may be referred to as the first video stream 125. The first video stream 125 is analyzed to determine whether a hand of the remote expert is present in the video stream and if so the position of the hand in the video stream. The video stream from the one or more cameras 220 of the AR headset which capture the field of view of the front line worker may be referred to as the second video stream 225. The second video stream is sent from the AR headset to the remote expert computing device.

The remote expert computing device 100 further comprises a 3D hand position determining module 130 and a video processing module 160, which may be implemented by a processor of the computing device 100. The 3D hand position determining module 130 is configured to receive a 2D video stream 125 from the 2D camera 120 and determine 3D coordinates of a hand of the remote expert in the 2D video stream. These 3D hand coordinates 135 may be sent to the AR headset 200 at the second location 20. For example the 3D coordinates may be sent over a network 40, such as the Internet, a wireless network or cellular communications network.

The AR headset 200 may comprise an AR mapping module 230 and a AR image rendering module 240, which may be implemented by a processor of the AR headset 100. The AR mapping module 230 is configured to receive the 3D hand coordinates of the remote expert's hand and map an AR model to the 3D hand coordinates in the frame of reference of the AR headset. For instance, the AR model may be a 3D model of a hand, a pointer or an AR model of a tool or other type of object. The AR image rendering module 240 is configured to render the AR model as a first AR image 245 to be displayed by the AR headset. The first AR image 245 may be a 3D image, such as but not limited to a hologram. In some examples the first AR image is a 3D representation of one of the remote expert's hands. In other examples the first AR image may be a pointer or an object such as a tool used in surgery, manufacturing, construction or another task.

By mapping the AR model to the 3D coordinates of the remote expert's hand in real time and rendering the AR model as an AR image, an AR image whose movements correspond to the remote expert's hand movements can be displayed on the screen of the AR headset. This enables the remote expert to guide and instruct the front line worker by using hand gestures in a simple and intuitive manner. That is, rather than working out what they would do and then putting this into words, moving a mouse pointer or tapping a touch screen, the remote expert can move their hands as if they were performing the task in-situ at the second location. Further, the method is very flexible as the remote expert can use any computing device with a display and a 2D camera, such as a lap top computer, tablet computer or mobile phone, without the need for complicated and expensive specialised hardware.

The AR headset may also comprise an AR and video stream merging module 250. The AR and video stream merging module 250 is configured to merge the second video stream 225 of the field of view of the front line worker with a second AR image based on the AR model or first AR image as mapped to the field of view of the front line worker (i.e. as mapped to the frame of reference of the AR headset). The merged second video stream and second AR image 255 are sent back to the remote expert computing device 100 where they are received by the video processing module 160 and displayed on the display 110 of the remote expert computing device. In this way the remote expert can see an AR representation of their hands (or other AR model such as a pointer) which they are using to guide the front line worker.

In this way the remote expert can see both the field of view of the front line worker and an AR representation of the AR model (e.g. AR image of the remote expert's hands or a pointer) as seen by the front line worker in their AR headset. The remote expert can thus see a representation of the AR image which is being used to guide the front line worker.

The second AR image may substantially correspond to the first AR image. In some examples the first and second AR images are the same. In some examples the first AR image is in 3D and the second AR image is a 2D version of the first AR image. The second AR image may be generated by geometric mapping, a machine learning model or a matric so as to map a 3D first AR image onto a corresponding 2D image. The second AR image may be a 2D image for easy display on a 2D display 110 of the remote expert's computing device 100. In this way the system may be used with many types of remote expert computing device, such as a lap top computer or tablet computer and specialised display hardware is not needed. In other examples the second AR image may be a 3D image for display on a 3D display, where the remote expert computing device is an AR headset or other device with a 3D display.

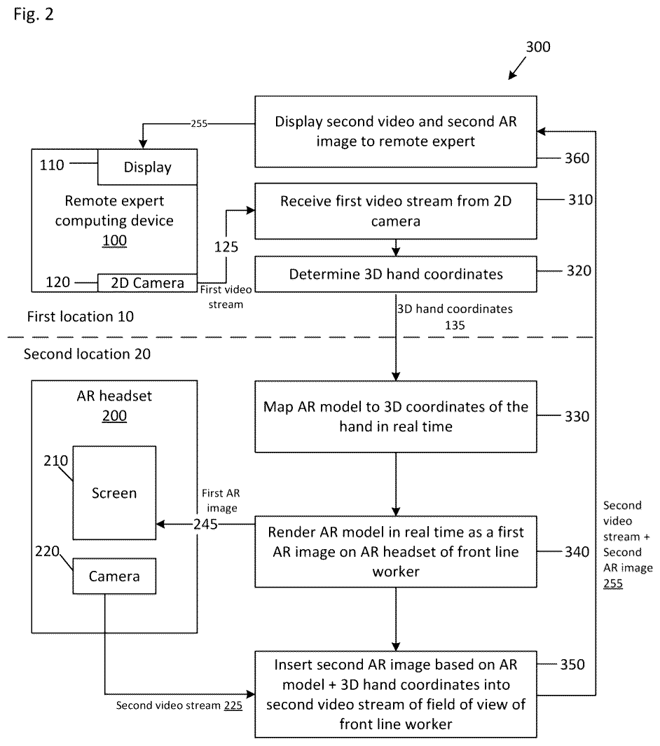

FIG. 2 shows a method 300 of using augmented reality (AR) to connect a remote expert at a first location 10 with a front line worker at a second location 20.

At block 310 a processor receives a first video stream 125 from a 2D camera 120 at the first location 10 where the remote expert is located. For instance the first video stream may be received from a 2D camera of a remote expert computing device 100.

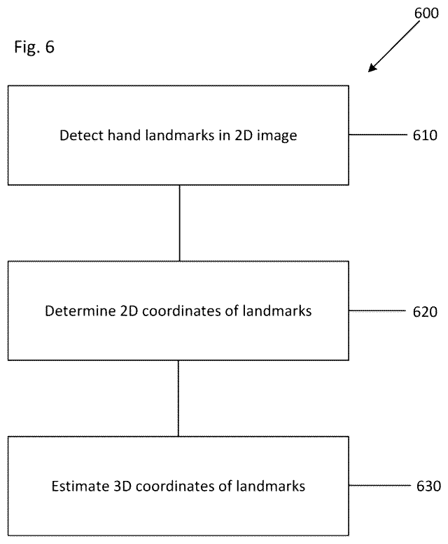

At block 320 a processor processes the first video stream in real time to determine 3D coordinates 135 of a hand of the remote expert in the video stream. 3D coordinates means having coordinates in three dimensions, for example x, y and z coordinates. One example of how the 3D coordinates may be determined is shown in FIG. 6.

At block 330 a processor maps an AR model to the 3D coordinates of the hand of the remote expert. The AR model is a model of something that may be displayed as an AR image. For example, the AR model may be a model of a hand, a pointer or another object. The AR model may include one or more points. The AR model may be in 3D. In some examples the AR model may take the form of a point cloud.

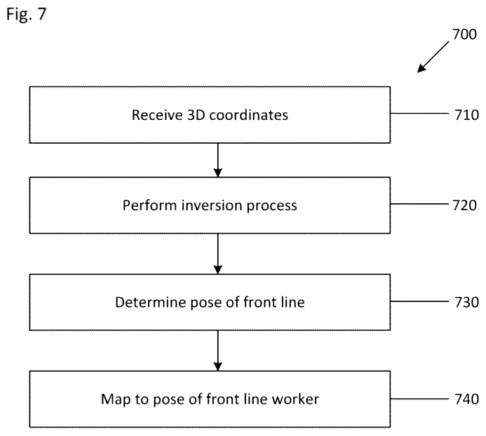

In some examples, mapping of the AR model to the 3D coordinates of the hand of the remote expert includes converting the 3D coordinates of the hand to the frame of reference of the front line worker. One example of how this may be carried out is shown in FIG. 7.

At block 340 a processor renders the AR model in real time as a first AR image in a AR headset 200 at a second location 20 at which the front line worker is located, the second location being remote from the first location. The rendering may for example include constructing a frame buffer for display on the screen of the AR headset and/or controlling LEDs of the AR headset 200 to form the first AR image.

The first AR image 245 may be in 3D. In some examples, the first AR image may be a hologram. Holograms may be formed dynamically in real time by controlling a number of LEDs to generate light rays which interfere with each other at the screen to form a hologram.

At block 350 a second video stream 225 of the field of view of the front line worker is captured by one or more cameras 220 of the AR headset 200 and a second AR image, corresponding to the first AR image, is inserted into or merged with the second video stream 225.

At block 360, the second video stream together with inserted second AR image 255 are displayed on the display of the computing device 100 used by the remote expert. For example, the second video stream and inserted second AR image 255 may be sent to the remote expert computing device 100 and processed by a video processing module 160 of the computing device to be displayed on the display 110 of the remote computing device as shown in FIG. 1.

The second AR image may be constructed based on the first AR image or based on the AR model. Merging or inserting the second AR image in the second video stream comprises may include mapping the 3D coordinates of the hand of the remote expert to the field of view of the front line worker. The second AR image is thus aligned with the frame of reference of the AR headset. In this way the remote expert gets to see the AR image from the perspective of the front line worker together with the field of view of the front line worker.

Blocks 310 to 360 described above are performed by one or more processors. The one or more processors may be located on one device or distributed over multiple devices in different locations. In one example blocks 310 and 360 are performed by a processor of the remote expert computing device 100 and blocks 330, 340 and 350 are performed by a processor of the AR headset 200; this is a peer to peer arrangement, as shown in FIG. 1. In other examples, some or all of the blocks may be performed by a processor of a server or a processor of a cloud computing service. In still other examples, some of the blocks may be performed locally on either the remote expert computing device 100 or the AR headset 200, while other blocks are performed on a server in the cloud.

As the method block are performed in real time, the front liner worker at the second location see as an AR image which moves at substantially the same time and in response to movement of the remote expert's hand at the first location. This is different to displaying pre-recorded video of predetermined hand movements. Where the processing of block 310 is carried out locally at the first location, e.g. by the remote expert computing device, this reduces latency as it is not necessary to wait for a response from a remote server as to the hand detection and 3D hand coordinates. Further, the volume of data needed to be transmitted to implement the AR model and first AR image at the second location is reduced as it is possible for the AR headset to receive the 3D coordinates and then map a locally stored AR model to the received 3D coordinates. This approach helps to reduce latency and improve the performance of the system, which is especially important for delicate and time critical tasks, such as surgery.

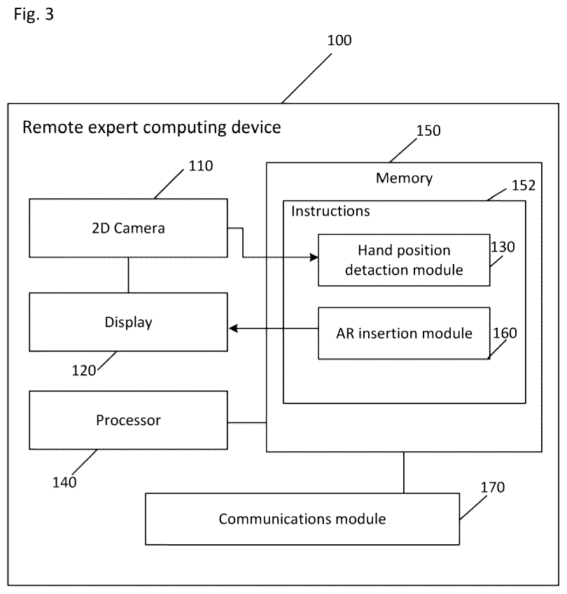

FIG. 3 shows a remote expert computing device 100 according to an example of the present disclosure. The remote computing device 100 includes a 2D camera 110 and a display 120, which are the same as described above in FIG. 1. The computing device further comprises a processor 140 and a memory 150 or a non-transitory machine readable storage medium storing instructions 152 which are executable by the processor. The processor 140 may for example be a central processing unit, a microprocessor, microcontroller or field programmable gate array (FPGA) or application specific integrated chip (ASIC) etc. or a combination thereof. The memory pr non-transitory machine readable storage medium may be a read only memory, random access memory, solid state storage, electronically erasable programmable read only memory, hard drive, solid state drive etc. or a combination thereof.

The instructions 152 may include instructions which when executed implement a 3D hand position detection module 130 and a video processing module 160 as described above in FIG. 1. The 3D hand position detection module 130 may perform blocks 310 and 320 of FIG. 2 and the video processing module 160 may perform block 360 of FIG. 2.

The computing device 100 further comprises a communications module 170 for sending and receiving communications over a communications link, such as but not limited to a network. For example, the communications module 170 may be a wireless interface for sending and receiving wireless communications such as wifi, Bluetooth, 3G, 4G or 5G telecommunication signals or a wired interface for sending and receiving communications over a wired link, such as but not limited to Ethernet.

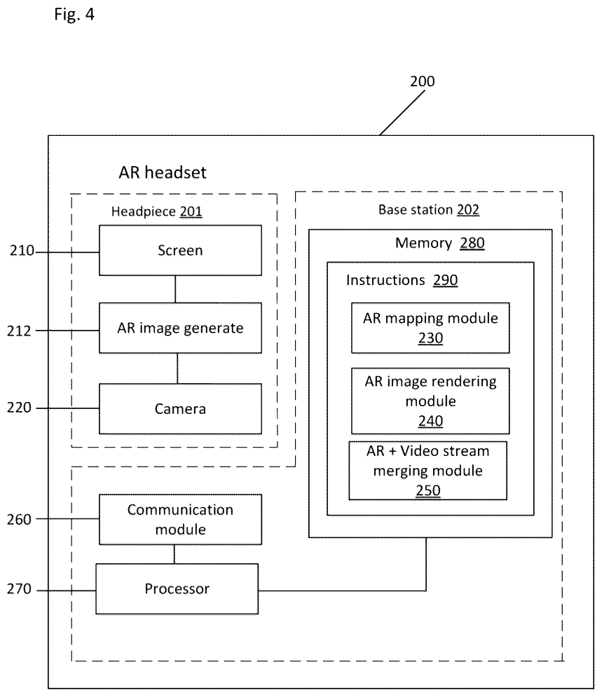

FIG. 4 shows an AR headset 200 according to an example of the present disclosure. The AR headset may be provided as a single part or split into several parts. In the example of FIG. 4, the AR headset includes a headpiece 201 which is to be worn on the head of the front liner worker and a base station 202 which is separate from the headpiece, but in communicative contact therewith. For example, the headpiece 201 may be connected to the base station 202 by a wired or wireless communication link. In general, a wired communication link, such as a cable, may be used so as to minimize latency. The base station 202 may carry out various computing tasks which are too processor intensive to be conveniently carried out by the headpiece.

The headpiece 201 comprises a screen 210 through which the front line worker may see the real world and superimposed AR image and one or more cameras 220 for capturing a video stream of the front line workers' field of view. The screen 210 and the one or more cameras 220 are as previously described in FIG. 1. The headpiece may further comprise an AR image generator 212 for generating the AR images which are to be displayed in front of the eyes of the front liner worker. For example, the AR image generator 212 may include one or more LEDs or lasers for projecting light beams onto the screen 210 in order to create the AR images. The headpiece may include a processor, such as a microcontroller (not shown) for controlling the AR image generator.

The base station 202 comprises a communication module 260, a processor 270 and a memory or non-transitory computer readable storage medium 280, which may be the same or similar to the communication module, processor and memory or storage medium of the remote computing device 100 described above in relation to FIG. 3. The memory 280 may store machine readable instructions 290 which are executable by the processor 270. The instructions 290 may include instructions which when executed implement a AR mapping module 230, AR image rendering module 240 and a AR and video stream merging module 250; these modules may have the same functionality as described in FIG. 1. The AR mapping module 230 may implement block 330 of the method FIG. 2, the AR image rendering module 240 may implement block 340 of the method FIG. 2 and the AR and video stream merging module 250 may implement block 350 of the method of FIG. 2.

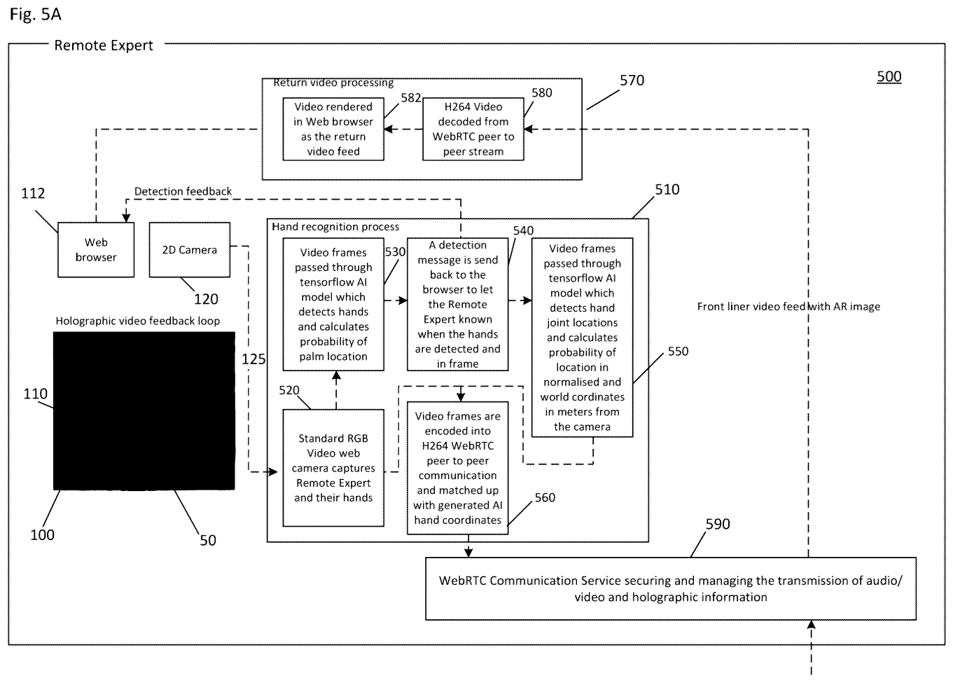

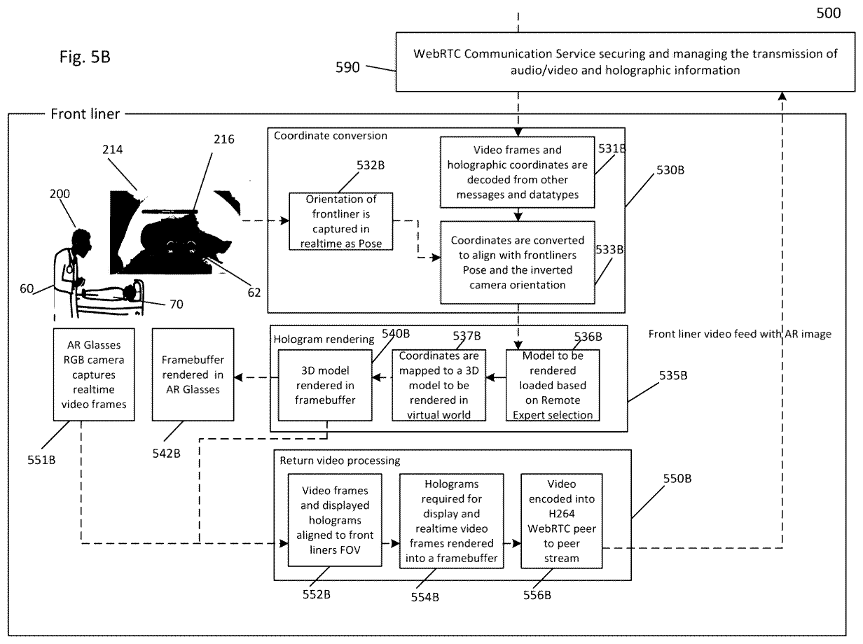

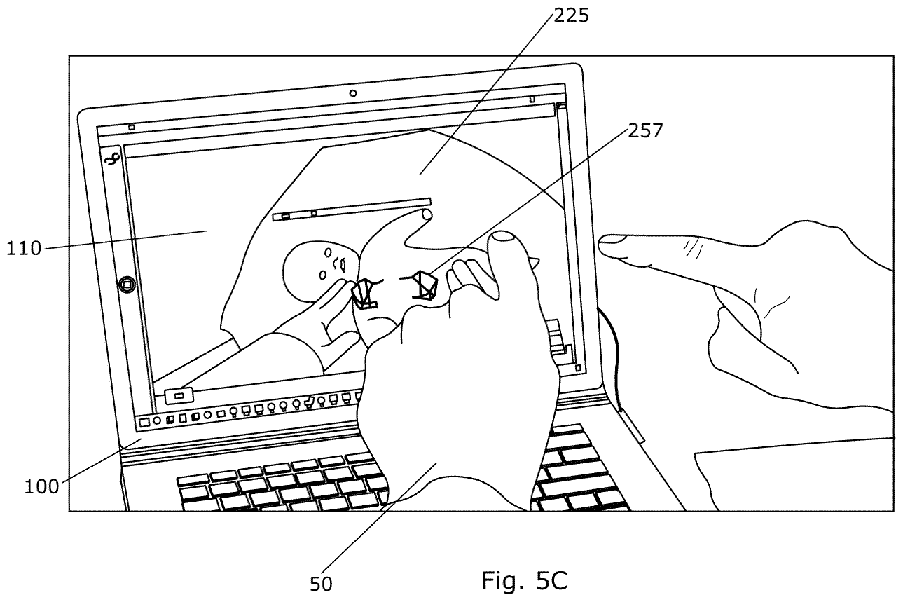

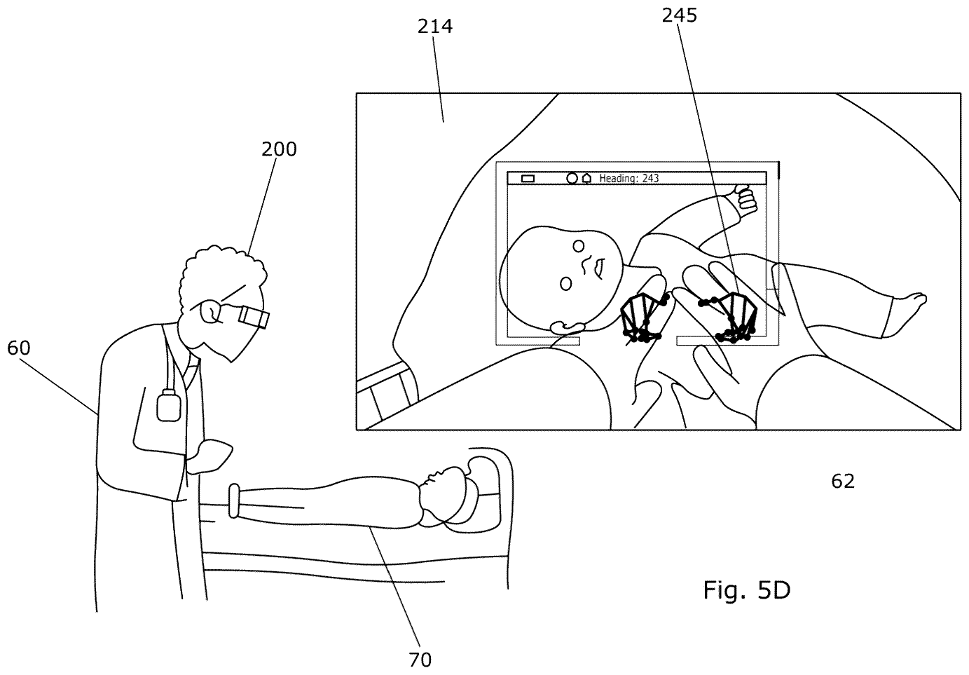

FIGS. 5A and 5B are schematic drawings which show a method 500 of using augmented reality (AR) to connect a remote expert at a first location 10 with a front line worker at a second location 20 according to a further example of the present disclosure. The method is similar to the method of FIG. 2, but includes further processes.

FIG. 5A shows method blocks including a hand recognition process 510 for gathering information for use in generating a hologram which tracks the remote experts hand movements and a return video process 570 for receiving and displaying a video feed of the field of view of the front line worker together with an AR image based on the generated hologram. In the example of FIG. 5A these method blocks are implemented by a web browser 112 running on the computing device 100 of the remote expert. In other examples the method blocks may be implemented by an app or other software executing on the computing device, or a combination of hardware and software. In other examples some or all of these blocks or sub-blocks may be implemented elsewhere outside of the remote expert computing device, such as on a server or in the cloud.

As shown in FIG. 5A, the remote expert has as computing device 100 which has a display 110 and a 2D camera 120. The 2D camera may for example be a RGB webcam. The 2D camera captures a first video stream 125 of the remote expert including the remote expert's hands 50. The display 110 displays a second video stream 225 showing a field of view of the front line worker as captured by a camera of the front line worker's AR headset. The display 110 of the remote expert computing device also shows an AR image 257 whose movement is controlled by movement of the remote expert's hands. An example of the second video stream 225 and the AR image 257 displayed on the display 100 are shown in FIG. 5C. The AR image 257 may for example be a pointer or a representation of the remote expert's hands. The AR image corresponds to the second AR image referred to in FIGS. 1 to 4 above. The combined second video stream and second AR image correspond to reference numeral 255 in FIGS. 1 to 4.

As mentioned above, in the example of FIG. 5A, the hand recognition process 510 is executed locally on the remote expert computing device 100. This helps to reduce network latency as the hand recognition can be performed without waiting for a response from a server and the volume of data which needs to be sent over a communication link is reduced.

The hand recognition process 510 is one way of implementing the 3D hand coordinate determination 320 of FIG. 2. The hand recognition process 510 may include the following blocks. At 520 the 2D camera 120 captures a real time video stream 125 of the remote expert and their hand (also referred to herein as a ‘first video stream’). At block 530 the video frames of the first video stream 125 are passed through a detection model which detects the presence of one or more hands and a location of the one or more hands. The location of the one or more hands may be expressed in 3D coordinates (e.g. x, y, z coordinates) in the frame of reference of the 2D camera. The detection model may be a machine learning or AI model trained on a training set to detect the presence and location of a hand. The detection model may calculate a probability of the palm location. In one example the detection model is a tensorflow AI model.

FIG. 6 shows one example of an AI hand detection method 600 which may be employed by block 520 of FIG. 5. At block 610 one or more hand landmarks are detected in the video frame (which is a 2D image). For example, a hand landmark may be the position of a palm, wrist or fingers of the hand which have a characteristic appearance and which the AI model has been trained to recognise. At block 620 the AI model determines the 2D coordinates of the hand landmarks in the 2D image. This may be expressed as a percentage probability of the landmark being at a particular coordinate. At block 630 the AI model estimates the 3D coordinates based on the 2D coordinates of the hand landmarks and other data from the 2D image. For example, the AI model may have been trained on a large number of 2D images and/or 2D landmark coordinates and corresponding 3D coordinates of the landmarks. The AI model is thus able to estimate the 3D coordinates of hand landmarks in the current frame based on the hand posture, the 2D coordinates, surrounding features of the image and/or the hand posture and position of 2D landmark coordinates in preceding and subsequent video frames. The 3D coordinates may be x, y, z coordinates and may be expressed in distance (e.g. meters) from the 2D camera. In some examples, the 3D coordinates comprise a point cloud generated from pixels of a 2D image of the hand captured by the 2D camera.

Referring back to FIG. 5A, at block 540 a detection message is sent to the remote expert, e.g. via the display or a browser of the remote expert computing device 100 to confirm that the hands have been detected. The message may indicate whether none, one or two hands are detected. The software may be configured to require detection of at least one hand or at least two hands. If no hands are detected, or if only one hand is detected, but two are needed for the current application, the remote expert may move their hands to a position where the necessary number of hands can be detected. A portion of the display 100 may show the first video stream 125 of the remote user, for instance the first video stream may be shown in a floating box or a box in the bottom right corner of the display 110, similar to a video call on which the caller can see themselves as well as the person they are calling. By looking at the first video stream 125 on the display 110, the remote expert can move their hands until they are in a position in which they can be detected by the 2D camera and the hand detection process 510.

While the 3D coordinates of the hand position, e.g. palm coordinates, may be sufficient to allow an AR pointer to be controlled by the remote expert's hand movements, in some cases it may be desirable to express more complicated hand movements or finger movements. Accordingly, in some examples determining the 3D coordinates of the remote expert's hand includes determining coordinates of hand joints of the remote expert's hands. The front line worker's AR headset may then be configured to render a 3D image of the remote expert's hand and hand joint movements in real time so that more complicated instructions and guidance can be delivered to the front line worker in an intuitive fashion.

Accordingly, at block 550, the video frame is passed through an AI model to detect joint locations of the hand, such as but not limited to the wrist, finger tips and knuckles. For instance, the landmarks may include one or more of the wrist, thumb, index, middle, ring and pinky finger Distal Interphalangeal Joint (DIP), Proximal Interphalangeal Joint (PIP Joint), Metacarpophalangeal Joint (MCP joint) and Carpometacarpal Joint (CMC Joint) as well as the finger tips. The AI model may have been trained on a large number of real world images of hands and/or synthetic hand models imposed over various backgrounds. The AI model may determine the joint landmark location based on the palm landmark location, 2D image data and the parameters of the pre-trained AI model. The location of the joints may be determined as 3D coordinates in terms of distance from the camera. Block 550 may use the method of FIG. 6 to determine the 3D joint coordinates.

At block 560 the video frames of the first video stream 125 from the 2D camera 120 and the 3D coordinates of the hand and hand joints are encoded for sending over a communication link. For example, the video frames may be encoded into H264 WebRTC or another video format. The video frames may be sent together with the 3D coordinates so that the front line worker can see remote expert (and also hear if the video includes audio) in a video feed transmitted to their AR headset 200. In the example of FIG. 5A, the 2D video frames and 3D hand coordinates are sent over a peer to peer link, such as a WebRTC Communication Service 590. In other examples, the 2D video frames and 3D hand coordinates may be sent indirectly via a server or cloud computing service.

In some examples, certain of the above sub-blocks may be omitted. For example, in some examples the 3D hand coordinates may be transmitted to the front line worker without the 2D video frames. In some examples, the detection message at block 540 may be omitted. In some examples, the method may detect the position of the hand as shown in block 530 without detecting the position of multiple hand joints as shown in block 550.

The manner in which the 3D hand coordinates and 2D video frames are processed for use by the AR headset will now be described with reference to FIG. 5B. After discussing FIG. 5B, we will return to block 570 of FIG. 5A which relates to processing of the return video feed of the front line worker by the remote worker computing device for display to the remote expert.

FIG. 5B shows method blocks including a coordinate conversion 530B, hologram rendering 535B and return video processing 550B. In the example of FIG. 5B these method blocks are implemented by the AR headset 200. In other examples some or all of these method blocks may implemented elsewhere outside of the AR headset, for instance on a server or in the cloud.

FIG. 5B shows a front line worker 60 who is wearing an AR headset 200. The front line worker is to perform a medical procedure, such as CPR, on the patient 70. The field of view of the front line worker through the AR headset is shown by graphic 214. The front line worker can see the patient, their own hands 62 and a first AR image 245 which moves based on the hand movements of the remote expert. The field of view of the front line worker and the first AR image are best seen in FIG. 5D, which shows an enlarged version of the view of the front line worker. In FIG. 5D, reference numeral 60 refers to the front line worker, reference numeral 200 to the AR headset worn by the front line worker and reference numeral 70 to the patient. Reference numeral 214 refers to the field of view of the front line worker through the screen of their AR headset, reference numeral 62 refers to the hands of the front line worker and reference numeral 245 refers to the first AR image, which in this is example is based on an AR model of the remote expert's hands.

The coordinate conversion 530B and hologram rendering 535B correspond generally to the function of blocks 330 and 340 of FIG. 2, while the return video processing 550B corresponds generally to the function of block 350 of FIG. 2. In the example of FIG. 5B these include various sub-processes which now be described.

In general, the 3D coordinates of the remote expert's hand are received by the AR headset of the front liner worker and the AR headset maps the AR model to the 3D coordinates of the hand of the remote expert. In some examples this includes determining an orientation or pose of the AR headset of the front liner worker and converting the 3D coordinates of the hand of the front liner worker to the frame of reference of the AR headset. The conversion process may include passing the 3D coordinates through an inversion matrix.

Referring to FIG. 5B, at block 532B the orientation of the front line worker is captured. The orientation of the front line worker may be referred to as the pose of the front line worker. The orientation may be determined by an inertial measurement unit of the AR headset. The orientation may comprise a pitch, yaw and roll of the AR headset relative to a neutral position. The neutral position may be set by a calibration process when the user first wears the AR headset. The AR headset may also capture the position of the front line worker in real space relative to an origin point which may be set during calibration.

At block 531B the 3D coordinates of the remote expert's hand are received. For example the coordinates may be received over a communication link or network. The 3D hand coordinates may be received over a peer to peer communication link 590 with the remote expert computing device, such as a WebRTC Communication Service, or may be via a server or the cloud. The 3D hand coordinates may include a position of the hand and may also include positions of the hand joints. Video frames of the remote expert may also be received over the communication link or network. The video frames and 3D hand coordinates may be received in coded form and decoded after reception from the communication link.

At block 533B the 3D hand coordinates are converted to align with the front line worker's pose or orientation. This conversion may include passing the coordinates through an inversion process, such as an inversion matrix. For instance, as the remote expert moves their hand away from themselves and towards the camera in the z direction, the coordinates should be converted so that the front line worker perceives the hand as moving away from themselves. Accordingly, the z coordinates may be inverted. Further, a movement which the camera perceives as to the left should be rendered as a movement to the right and vice versa in the frame of reference of the front line worker and their AR headset.

FIG. 7 shows one example method 700 of carrying out the conversion process. At block 710 the 3D hand coordinates are received. At block 720 an inversion process is performed on the 3D hand coordinates. At block 730 the pose or orientation of the front line worker is determined, e.g. by an IMU of the AR headset. At block 740 the inverted 3D hand coordinates are mapped to the pose of the front line worker.

The AR headset may overlay various AR elements, a user interface and/or a video feed (the first video stream) of the remote expert on the front line worker's view of the real world through the screen of the AR headset. The different elements may be deployed as different layers. Some of these elements, in particular the user interface, may remain stationary while the front line worker moves their head. In this way, the front line worker is able to interact with the user interface and select different elements of the user interface. Other AR elements may move together with the field of view of the front liner worker as the front line worker turns their head. In order to implement this, the various elements may be deployed in different layers. Each element may have a fixed position in the virtual world created by the AR headset, or may be floating in that it moves together with the front line worker.

Where the AR image corresponding to the remote worker's hands is floating, i.e. where it is to move together with the front line worker, the mapping may simply comprise directly mapping the inverted coordinates onto the frame of reference of the AR headset. Where the AR image is to be fixed, e.g. so it is not seen if the front line worker turns their head, then a translation calculation is carried out to determine the coordinates relative to the front line worker's field of view.

At block 536B an AR model that is to be rendered is loaded. The AR model may be selected by the remote expert. For example, the AR model may be a pointer o a representation of the remote expert's hand or hands. The AR model may comprise a plurality of points or a point cloud. At block 537B the AR model is mapped onto the 3D coordinates of the remote expert's hand which have been converted to the frame of reference of the front line worker in block 533B. At block 540B the AR model, which may be a 3D model, is rendered in a frame buffer for display by the AR headset.

At block 542B the frame buffer is rendered by the optical hardware of the AR headset so as to create the first AR image which corresponds to the AR model. For example the first AR image may be rendered as a 3D image or a hologram viewable on or through the screen of the AR headset.

The return video processing will now be described. Referring to FIG. 5B, at block 551B one or more cameras of the AR glasses capture a real time video stream of the field of view of the front line worker. This video stream may be referred to as the ‘second video stream’. At block 552B frames of the video stream are merged in real time with the AR model or with the first AR image generated in block 535B. For example, a second AR image may be generated based on the AR model or AR image and inserted into the second video stream. This may involve aligning the AR model or AR image with the second video stream based on the 3D hand coordinates which were converted in block 533B. The first AR image may be a 3D image which is to displayed e.g. as a hologram by the AR headset, the second AR image may be a 2D image which is to be displayed on a 2D display of the remote expert. However, in some examples the remote expert computing device may have a 3D display, for instance if the remote expert computing device comprises a 3D screen or an AR headset. Where the second AR image is a 2D image it may be constructed in real time based on the real time generated AR model or first AR image.

At block 554B, the second AR image and aligned second video stream are rendered into a frame buffer. At block 556B the frame buffer containing the second video stream and second AR image is transmitted to the remote expert computing device. For example, the transmission may be over a peer to peer communication link, a network or similar. The second video stream and second AR image may be transmitted directly or indirectly via a server or cloud computing service. In some examples the second video stream and second AR image may be encoded before transmission, for example into a H264 WebRTC peer to peer stream or other format. At block 590 the encoded video stream and AR image is transmitted over the network or peer to peer link.

Referring now to FIG. 5A, the encoded second video stream and second AR image is received and decoded at block 580. At block 582, the second video stream of the field of view of the front line worker and the second AR image are rendered in real time on the display of the remote expert computing device. For example, the video and AR image may be rendered in a web browser or application software running on the remote expert computing device. An example of the view is shown in FIG. 5C.

It will be appreciated from the above that a computing device of the remote expert at the first location includes a 2D camera, a processor and a display for displaying the second video stream of the field of view of the front liner worker and the second AR image to the remote expert. The AR headset sends a second video stream of the field of view of the front line worker to the remote client device of the remote expert and integrates a second AR image 257 corresponding to the first AR image seen by the front line worker into the second video stream 225. In this way the remote expert is able to see both the field of view of the front line worker and the hologram of the hands 257, pointer or other AR object which the remote expert controls via their hand movements, as shown in FIG. 5D.

It will further be appreciated that the processes shown in FIGS. 2, 5A, 5B and 6-7 are carried out in real time. That is the first AR image in the AR headset and the second AR image on the display of the remote expert computing device moves at substantially the same time as the remote expert moves their hands. This is different to displaying a pre-recorded AR animation in an AR headset. As the remote expert is able to control the AR image based on their hand movements they are able to guide and instruct the front line worker in an intuitive manner. They may also impart detailed instructions and movements were the AR model includes their fingers or joints and so can display the join movements.

Further, the method as described above may be implemented on a wide variety of remote expert computing devices and does not require the remote expert to have access to specialised hardware. As the method can use 2D video of the remote expert's hands from a conventional 2D camera and use software to determine the 3D coordinates and convert these to the frame of reference of the front line worker, the system can be run a normal lap top computer or tablet computer. The method is also flexible in that the AR image may be a representation of the remote expert's hands, a pointer or other object and may be selected from a library of available AR models. Thus different AR models could be used for different tasks or different sections of different tasks as required.

Further, in implementations where the 3D coordinate determination and AR model mapping is carried out on the remote expert computing device and the AR headset, rather than a remote server, latency is reduced and the volume of data needed to be transmitted is reduced. This is important in time critical applications such as surgery.

### Second Embodiment: Remote Lighting

A second embodiment of the present disclosure relates to lighting systems and in particular to lighting systems for augmented reality devices. The second embodiment allows a remote expert at a first location to remotely control one or more lights associated with an AR headset which illuminate the field of view of a front line worker. The second embodiment may be used by itself or in combination with the first and/or third embodiments.

Lighting conditions can play an important role in performing a manual task successfully. It can be difficult or impossible to perform a manual task without being able to clearly see the task being performed. Poor lighting conditions can result in the failure to perform a complex or delicate task. This becomes more complicated when a task is being carried out collaboratively via a video link. For example, where a front line worker at a first location wears an augmented reality headset which has a camera streaming a video of their field of view to a remote expert at a second location.

The human eye is able to rapidly adapt to sharp changes in lighting conditions. Thus, when turning one's head towards or away from a lighting source or an area of sunlight to an area of shadow, the human eye presents a relatively seamless view of the world. However, this is not the case for cameras which are very sensitive to light levels and changes in light and unable to adapt so rapidly. Even with autofocus and lens aperture adjustment sharp changes in contrast as the field of view moves can result in a video stream from a camera being saturated with light or too dark to clearly make out an area of interest. As a result the video stream transmitted to the remote expert may be overexposed or too dark to see the requisite level of detail clearly.

While performing a manual task, a light source may need to be repositioned or adjusted to improve lighting conditions. This becomes more complicated when a task is being carried out collaboratively over a video link. The front line worker may have enough light to carry out the task and may not be aware that the video stream presented to the remote expert is oversaturated or is dark with poor contrast. This is especially the case for augmented reality headsets, where the front line worker may not see the video stream presented to the remote expert. This can result in a disruptive process, where the remote expert is constantly asking for the lighting to be adjusted and because it is hard to verbalise the necessary adjustment multiple requests and adjustments may be needed.

In the context of collaborative surgery, for example, the remote expert (also referred to as a remote collaborator) might need to ask the in situ person to adjust the lighting until the images or video on the remote expert's display are clear enough to check that the surgery is being performed safely. The remote expert may wish to view the surgery under varying intensity ultraviolet or infrared light. Each time the remote expert wishes to control the lighting they need to ask the front line person (or another person in situ at the second location) to do this. The remote expert is completely dependent on the in situ person to adjust the lighting for them. Controlling lighting this way during AR remote collaboration wastes time and is necessarily disruptive to performing the task.

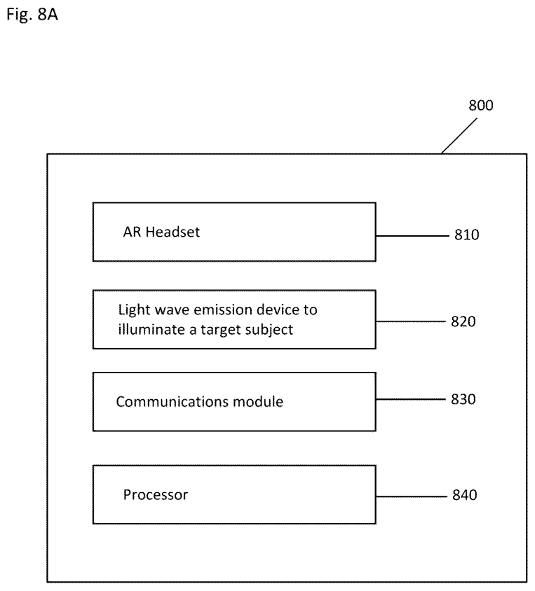

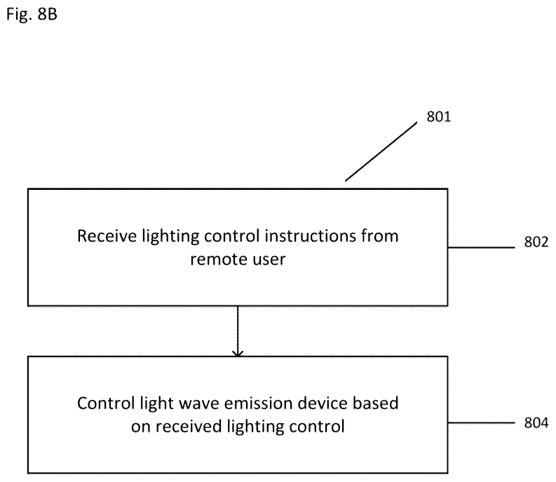

Accordingly, as shown in FIG. 8A, the second embodiment proposes an augmented reality (AR) lighting system 800 comprising: an AR headset 810; a light wave emission device 820 for projecting light onto an area in front of the AR headset to illuminate a target subject; a communications module 830 for receiving lighting control instructions from a remote user (e.g. the remote expert); and a processor 840 for controlling the light wave emission device in accordance with the lighting control instructions from the remote user. The AR headset may have any of the features described above in relation to the first embodiment or below in relation to the third embodiment.

FIG. 8B shows a method of operation 801 of the lighting system 800. At block 802 the light wave emission device receives control instructions from the remote user. E.g. these instructions may be received via the communications module 830. At block 804 the light wave emission device is controlled by the processor 840 based on the received lighting control instructions.

In some implementations, the light wave emission device 820 may be integral with the AR headset. In other implementations the light wave emission device 820 may be separate from the AR headset and mountable to the AR headset, e.g. as shown in FIG. 9.

The light wave emission device 820 may comprise one or more lights for projecting light onto an area in front of the AR headset to illuminate a target, such as a work area or a patient to be operated on. In some examples, the light wave emission device may comprise two or more independently controllable lights for projecting light onto a target subject in front of the AR headset. The provision of two or more independently controllable lights has several advantages as will be described later. The lights may be light emitting diodes (LEDs). The light wave emission device 820 may be implemented as a light bar with one or more lights which sits on top of the AR headset. For instance the light wave emission device may clip onto a frame of the AR headset. This enables the light wave emission device 820 to be used with a wide variety of AR headsets.

The light wave emission device may have a communication interface such as a wired connection, USB connector, wireless module such as Bluetooth module to receive power from and/or communicate with or receive instructions from the AR headset. This enables the light wave emission device 820 to be used with a wide variety of AR headsets.

The processor 820 may be configured to control the brightness of one or more lights of the light wave emission device in accordance with the lighting control instructions. Alternatively or additionally the processor may be configured to control the frequency (including but not limited to colour) of one or more lights of the light wave emission device in accordance with the lighting control instructions.

The communications module 830 may for example be a wireless communication module or a wired communication module, similar to the communications modules describe above in relation to the AR headset. In some examples the light wave emission device may have its own communications module while in other examples the light wave emission device may use the communications module of the AR headset.

The AR lighting system may further comprise a remote control device for use by a remote user (e.g. remote expert). The remote control device may be configured to generate lighting control instructions for the light wave emission device based on the remote user input and to send the lighting control instructions to the AR headset and/or light wave emission device.

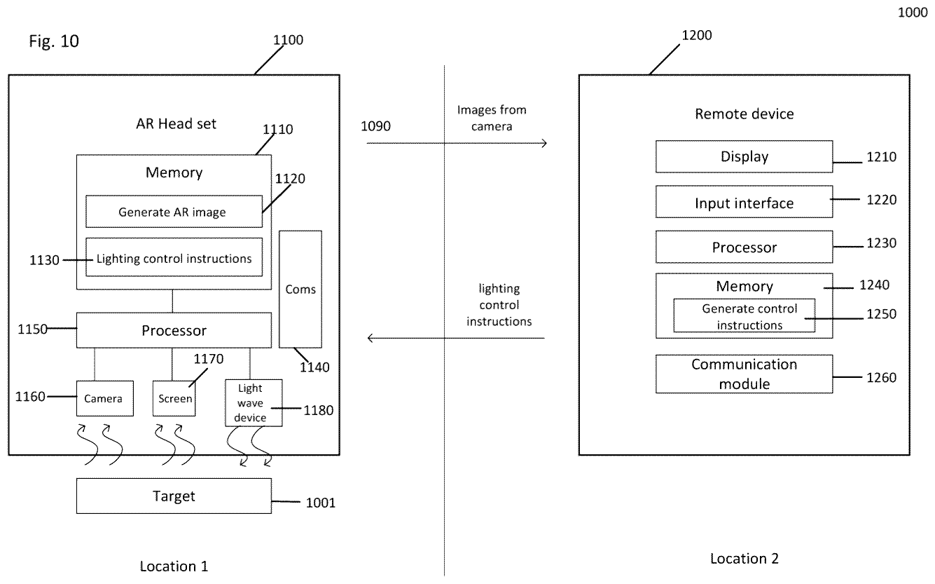

An example is shown in FIG. 10. The AR lighting system of FIG. 10 comprises an AR headset 1100 including a light wave emission device at a first location and a remote control device 1200 at a second location.

The AR headset 1110 comprises a camera 1160 for capturing a video stream of a target 1001 such as a patient or a work area, a screen 1170 through which the front line worker wearing the AR headset can see the real world including the target 1001 and a light wave emission device 1180. The screen may be a transparent screen. The AR headset may have any of the features of the AR headset of the first embodiment described above or the third embodiment described below. The AR headset further comprises a communications module 1140 which corresponds to the communications module 830 and a processor 1150 which may correspond to the communications module and processor of FIG. 8 described above. The processor may for example be a central processing unit, a microprocessor, a microcontroller, a FPGA or an ASIC etc. The AR headset further comprises a memory 1110 storing instructions which are executable by the processor. The instructions include instructions 1120 to generate a virtual image such as an AR image on the headset and lighting control instructions 1150. In some examples, the lighting control instructions and processor for implementing the lighting control instructions may be integral with the light wave emission device. The lighting control instructions may be in the form of dedicated hardware or hardware and software for implementing lighting control instructions received from the remote control device 1200 via the communications module 1140. In other examples, the lighting control instructions and processor for implementing the lighting control instructions may be part of the AR headset which controls the light wave emission device.

The remote control device may be implemented by the remote expert computing device, for instance by software running on the remote expert computing device. In other examples the remote control device may be another device at the second location which is separate from the remote expert computing device. The remote control device 1200 may comprise a display 1210, a input interface 1220 (which may be a GUI displayed on the display 1210), a processor 1230, a memory 1240 and instructions 1250 executable by the processor to generate lighting control instructions for transmission to the AR headset via a communications module 1260 of the remote control device 1200.

The remote control device 1200 is configured to generate lighting control instructions for the light wave emission device based on the remote user input and to send the lighting control instructions to the AR headset and/or light wave emission device. In this way the remote user can adjust the level of lighting to the desired level without requesting assistance from the front line worker to change the lighting. The remote user may vary the lighting from time to time as the front line worker changes their field of view and lighting conditions change or to illuminate specific areas of interest.

Further, the lighting control instructions may change the frequency of the one or more lights in order to highlight specific features of interest on the target. For instance the remote user may change the frequency of the illumination to highlight specific features (for instance if detecting veins which are a blue colour, the remote operator may adjust the lighting to a pink colour which will effectively filter out non-blue wavelengths, or vice versa if detecting inflammation).

While not shown in FIG. 10, in some examples the lighting system may further comprise a server for receiving lighting control instructions over a network from the remote control device and sending the lighting control instructions over a network to the light wave emission device and/or AR headset.

In some examples, the remote control device may be configured to generate lighting control instructions to control a first light and a second light (e.g. first and second LEDs) of the light wave emission device to emit different frequencies of light from each other in response to a control input from the remote user. As shown in FIG. 10 the light from the light wave emission device may be reflected back from the target to a camera 1160 of the AR headset. It is possible to detect and distinguish the reflected light originating from the first light and the reflected light originating from the second light as the first and second lights have different frequencies. Further by knowing the separation distance of the two lights from each other on the light wave emission device, it is possible to triangulate the reflected light in the image captured by the camera to determine depth in the image. An indication of image depth may then be indicated on the video stream fed back to the remote expert. By controlling the individual lights and detecting reflected light, various analysis of the image may be conducted by artificial intelligence or machine learning modules to provide useful information to the remote expert.

The lighting system may generate lighting control instructions to independently control a plurality of lights of the light wave emission device, receive the reflections of light emitted from the plurality of lights onto a target subject and reflected back to the AR headset, and analyse the reflections to determine a characteristic of the target subject. The lighting control instructions may be generated based on input by a remote user at the remote device. The instructions may be transmitted to the AR headset, which controls light of light emitting device and receives reflections at a camera thereof. Information on the reflections may be transmitted to a server for analysis.

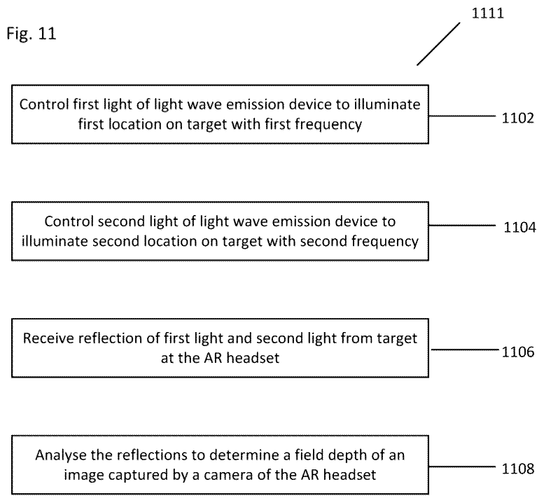

In some examples, the AR lighting system may be configured to determine a field depth of an image captured by a camera of the AR headset. A method 1111 of doing this is shown in FIG. 11. At block 1102 a first light of the light emitting device is controlled to emit light of a first frequency to illuminate a first location on a target in front of the AR headset, at block 1104, which may be simultaneous with block 1102, a second light of the light emitting device is controlled to emit light of a second frequency to illuminate a second location on a target in front of the AR headset. At block 1106 reflections of the first light and second light are received from the target at the AR headset (e.g. at a camera of the AR headset). At block 1108 the received reflections are analysed to determine a field depth of the image.

Light intensity and frequency can be used in a variety of ways to reveal features of a target object. For example, infrared light can show veins beneath the skin more clearly. Green light can show red objects as dark and vice versa. Ultraviolet light can vividly highlight lighter colours. The lighting system of the present disclosure makes it possible for a remote user to use these properties to get a clearer picture of the target or to highlight particular features.

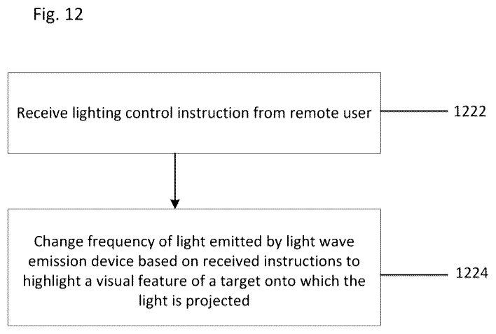

In some examples, in response to an instruction from the remote user, the light wave emitting device may highlight one or more specified visual features of a target by changing colour of the lights projected onto the target. For example, the remote computing device may have a user interface which allows the user to request certain features are highlighted (e.g. “highlight veins”) and configured to generate control instructions such as altering the frequency of the lights of the light wave emission device to highlight the desired feature. An example is shown in FIG. 12 in which the light wave emission device receives a lighting control instruction from the remote user at block 1222 and changes the frequency of the light emitted by the light wave emission device based on the received instructions to highlight a visual feature of a target onto which the light is projected at block 1224. Other examples include a user interface option to “show depth” whose selection may cause the light wave emission device to control first and second lights independently to emit different frequencies as discussed above.

A remote expert may wish to capture images or video and review them in parallel to watching a live feed of an in situ task, or they may wish to save images or video and review them later. The system of the second embodiment makes it possible for a remote expert at first location to control an in situ AR headset at a second location remote from the first location to save the images, e.g. by sending a control instruction to the camera or processor of the AR headset.

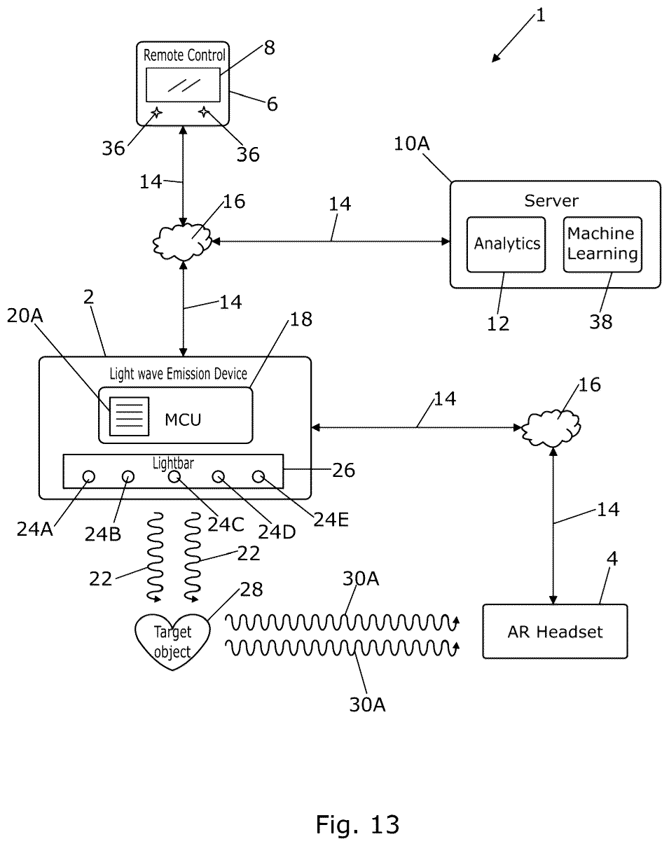

A further example of the second embodiment will now be described with reference to FIG. 13. Referring to the FIG. 13, the AR lighting system 1 may include a light wave emission device 2, an AR headset 4 associable with the light wave emission device 2, a remote control device 6 associated with a graphical user interface (GUI) 8, a server 10A, and a server-based analytics platform 12. Some or all of the foregoing elements may be in communicative contact, for example by being operatively connectable to a common communications network 16, as shown in FIG. 13.

In the example of FIG. 13, the light wave emission device has a microcontroller unit (“MCU”) 18 storing machine-readable code containing a set of instructions 20A for controlling light wave emission 22 from the device. The MCU 18 can also receive light wave emission control instruction inputs (not shown) from the network 14. The light wave emission device 2 also has an array of Light Emitting Diodes (“LEDs”) 24A to 24E arranged into a light bar 26 operatively connected to the MCU 18 by means of a printed circuit board (“PCB”) (not shown) having a shape conforming with the shape of the light bar 2. The light wave emission device 2 can be adapted to have any suitable number of LEDs.

The MCU 18 can for example be implemented by a microcontroller or SoC, and that reference to an MCU includes reference to other ways of implementing the light wave emission device using various computing devices (not shown).

Light wave emissions 22 having a different frequencies can be projected from one or more LED located at each end of the light bar and onto a target subject, such as, for example, LED 24A and LED 24E. Each light frequency 22 can be selected by means of a lighting control instruction (also referred to as a light wave emission control instruction) 20 such that the light wave emission 22 from each LED 24A and 24E combines to create a field depth effect on target subject 28 video or image signals 30 receivable by the AR headset 4.

The light wave emission device 2 may be contained within a protective housing 32 generally conforming to the shape of the light bar and PCB (not shown), as best seen in FIG. 2. The housing 21 may have a plug and socket arrangement adapted to attach the light wave emission device to the AR headset (not shown). In one example, the light wave emission device 2 is in operatively connected to the AR headset 4 by means of any one or more of SPI, I2C, USB, UART, Bluetooth, WIFI, Zigbee, Lora or similar (not shown).

The remote control GUI 8 is adapted for receiving and displaying images (not shown) from an AR headset 4 operatively connected 14 to the 16 network. The remote control 8 can have hardware inputs 36 such as buttons, knobs, sliders, haptic devices, as well as others. The light wave emission device 2 is adapted to receive light wave emission control instruction inputs (not shown) in the form of light wave emission control instruction inputs (not shown) generated by the remote control device 6. The remote control device 6 may also be adapted to control various AR headset 4 features such as recording of images and video, as well as others, by means of the common communication network 16.

The communication network server 10A may be adapted to coordinate communications between the remote control device 6, the head set 4, and the light wave emission device 2. The server 10A may host an analytics platform 12 adapted to receive signals data from one or more network devices and analyse the data by means of image analytics and ML model outputs 38. Each of the various referred to devices in communication 14 with the network 16 may be operatively connected to the network 16 by means of a suitable network software stack (not shown).

Light wave emission instruction inputs (not shown) can be generated based on light wave signals 30A received by the headset 4. The light wave signals 30 can be analysed by the analytics platform 12 before they are communicated to the light wave emission device 2 or control device 6, or they can be sent directly to the light wave emission device 2 or control device 6.

Light wave emission control instruction parameters (not shown) in the form of light wave brightness, light wave colour and tone, or another parameter, can be set such that light waves emitted 22 onto and reflected 30 from a target object 28 generate information signals (not shown) receivable by the headset 4 thus forming a forming a feedback control loop. These signals (not shown) can be analysed by means of the analytics platform 12, or may be directly communicated back to the light wave emission device 2 or to the control device 6 and presented on the control device's GUI 8.

To use the AR lighting system 1, an in situ user (e.g. front line worker) may first connect the light wave emission device 2 to the AR headset 4 if they are separate pieces. The in situ user and a remote user (e.g. remote expert) then make operative connections 14 between the light wave emission device 2, AR headset 4, remote control 6 and GUI 8, the network server 10, and server-based analytics platform 12, for communicating by means of a common communication network 16.

Next, the in situ user performs a task wearing the AR headset 4 and connected light device 4. The light waves 22 are emitted from the lightbar 26 LEDs 24A to 24E to create a lighting condition (not shown) for the target object 28. The AR headset 4 by means of an integrated camera (as best seen in FIG. 2), receives the light wave emissions 30 reflected from the subject target 28 as well as well as its surroundings (not shown) and communicates these in the form of video and images (not shown) by means of the network 16 to the GUI 8 associated with the control device 8 in real time. The remote user can view the video and images to provide verbal, written, or symbolic feedback to the in situ user to assist them in performing the task (not shown).

The remote user is able to control the light wave emission device 2 by manipulating hardware inputs 36 of the control device 6. The user can remotely increase or decrease the brightness of the light, the colour of the light as desired (not shown). When the remote user manipulates a hardware input 36 a light wave control instruction input is sent from the control device 8 via the network 16 to the MCU 20 to produce the desired light wave emission 22 from the light wave emission device 2. The remote user is also able to turn on a differently coloured LED light 24A and 24E located at each respective end of the lightbar 26 to create a field depth effect (not shown) on the target subject 28 and corresponding target subject image signals 30 receivable by the AR headset 4.

The server 10A coordinates communications between the remote control device 6, head set 4, and light wave emission device 2. The analytics platform 12 hosted by the server 1A0 can be used to receive signals data and other data (not shown) from the various devices in the network and perform analytics 12 on the data in the form of image analytics and (machine learning) ML 38 model outputs.

The remote user can also control the AR headset 4 to cause it to take video and images independently (not shown).

It will be appreciated that the illustrated AR lighting system allows a remote collaborator to control the lighting conditions of an in situ AR headset, directly control an in situ AR headset to capture images or video, make use of the properties of light, and make use of AI, ML, and Analytics.

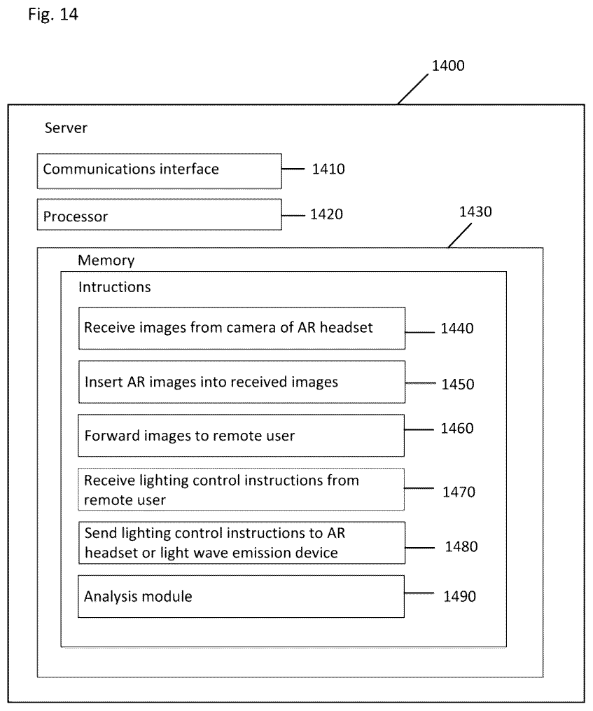

FIG. 14 shows an example of a server 1400 which may be used in combination with the lighting system. The server may in some examples be implemented as cloud computing service. The server 1400 comprise a communications interfaced 1410, a processor 1420 and a memory or non-transitory storage medium 1430. The memory stores instructions executable by the processor. The instructions may include instructions 1440 to receive images from the camera of AR headset, instructions 1450 to insert VR or AR images into the received images and instructions 1460 to forward the received images with inserted AR or VR images to a remote user, such as a remote expert. The instructions may further comprise instructions to receive lighting control instructions from a remote user and instructions 1480 to send the lighting control instructions to the AR headset or light wave emission device. The server 1400 may further include ana analysis module 1490 for analysing the received images using machine learning or otherwise.

### Third Embodiment: Light Guide/Prism

The third embodiment of the present disclosure relates to optics and in particular to optics systems for augmented reality headsets. The third embodiment of the present disclosure provides a device which allows the remote expert to view an area which is not directly in front of the front line worker. This allows an augmented reality headset user to position their body comfortably while performing an augmented reality task.

The third embodiment may be used by itself or in combination with the first and/or third embodiments.

When using an augmented reality headset a user (e.g. front line worker) wears the AR headset on their head. Wearing the AT headset over long periods of time may become burdensome especially if the front line worker is required to lean over while wearing a headset in order to give a remote expert receiving a video stream from a camera of the AR headset a clear view of a work area or patient directly in front of and beneath the front line worker. The headset user can get a sore neck and back, or become fatigued and be unable to continue with the task.

The optics system for an augmented reality headset described below may allow a user stand up straight and keep their head upright while using the headset.

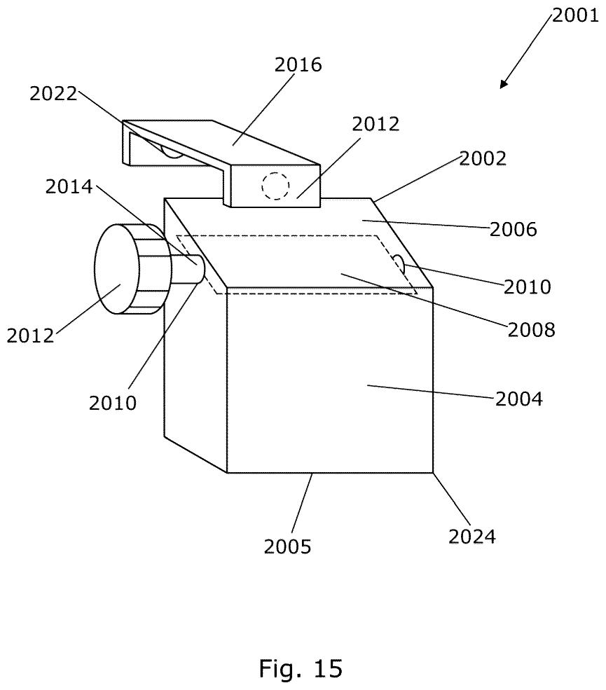

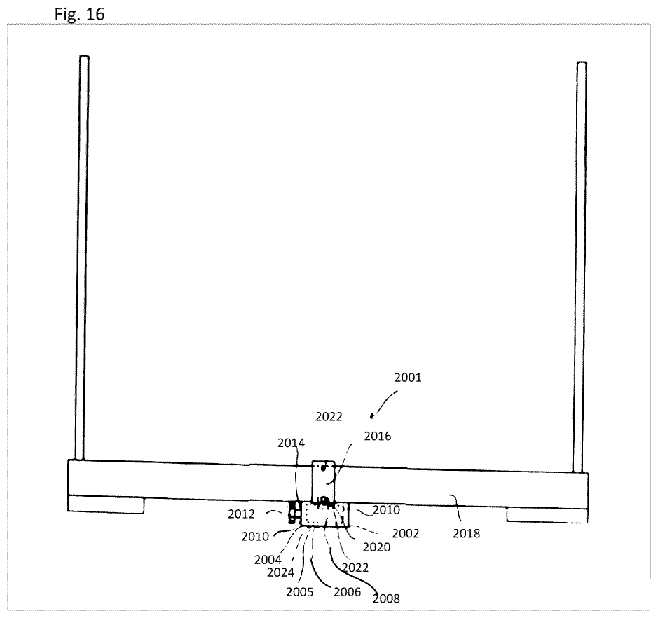

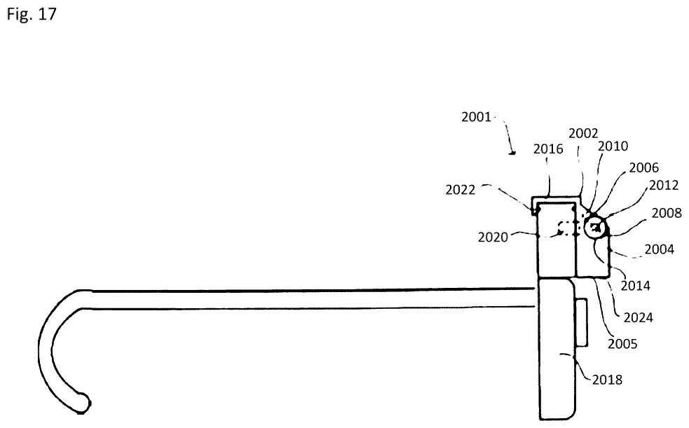

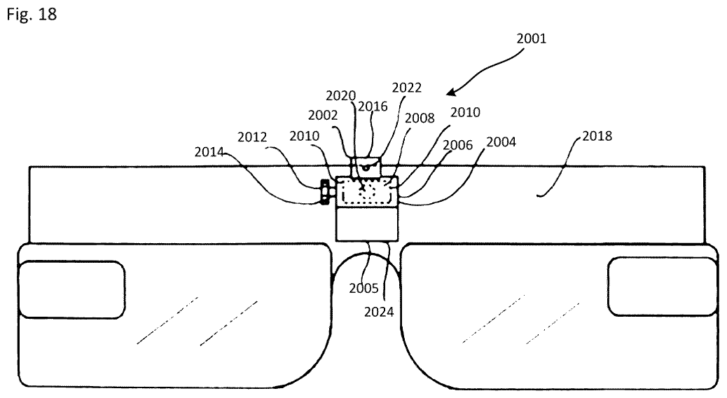

An example of an optics system 2001 for an augmented reality headset according to the third embodiment is shown in FIGS. 15 to 18. The system comprises: an optics device 2001 including a light guide 2004 and reflector 2008 for redirecting light from in front of and beneath the augmented reality headset into a camera of the AR headset (not shown). The reflector 2008 may for example be a mirror, reflective element or a prism. The AR headset may have any of the features of the AR headsets of the first and second embodiments discussed above. The optics system further comprises an attachment part 2016 for attaching the optics system to the augmented reality headset. In other examples, instead of an attachment part for attaching to an AR headset, the optics system may be integral with the AR headset.

The light guide 2004 may include a tubular body having a bend 2006 at one end of the body. The reflector 2008 is located inside the tubular body. The reflector may be located inside the bend of the body and maybe positionable to reflect light entering an opening at the first end of the body and out of a second (the bent end) into a camera of the AR headset. In some examples the reflector has a fixed position. In other examples the reflector is rotatably connected to the inside of the optics device so that the reflector may be rotated to vary the angle at which it redirects the incoming light.

For instance, the body may have an opening and the reflector may be accessible for rotation through the opening. The reflector 2008 may be rotatably connected inside and to the body by each one of two opposing reflector ends 2010. In some examples, a thumbwheel 2012 be used to rotate the reflector and change the angle of reflection of incoming or outgoing light. For example, the thumbwheel 2012 may extend from and to coaxially to the rotation axis of the reflector 2008 and through an opening 2014 of the tubular body 2004. In this way the reflector 2008 is accessible for rotation from outside of the tubular body 2004.

The attachment part 2016 may comprise a clip, ball and detent arrangement or a fastener arrangement. FIG. 15 shows a ball and detent arrangement 2022. The inside of the lightguide 2004 may be coated with a non-reflective coating. This avoids unwanted reflections which may distort the image, so that substantially the only reflection is by the reflector in the intended direction. The optics system may further including software or an optical arrangement for flipping an images received by the camera of headset, such that the image is flipped along its horizonal axis.

As explained above, the optics system 2001 may have an attachment 2016 for attaching the optics device 2002 to an augmented reality headset 2018 such that light (not shown) entering the other end 2005 of the tubular body 2004 and exiting out of the bent end 2006 enters a camera 2020 of the augmented reality headset 2018. In some examples, the attachment 2016 may be in the form of a clip, as seen in FIGS. 15 to 18. Images or video (not shown) received by the camera 2020 of the augmented reality headset 18 may be flipped along their horizontal axis by means of software or an optical arrangement (not shown) associated with the augmented reality headset 2018 to correct their orientation.

A optical magnifying element (not shown), such as a lens may be included on the optical path between the first and second ends of the light guide in order to magnify the image reflected into the camera of the AR headset.

In use the optics device 2001 may be attached to the headset 2018 by means of the attachment 2016. The AR headset 2018 can be worn on the user's head (not shown). Next, the thumbwheel 2012 can be rotated to position the reflector 2014 such that light (not shown) entering an opening at the other end 2005 of the body 2004 can be reflected to exit out of the bent end 2006 and into a camera 2020 of the augmented reality headset 2018. The image or video received by the camera 2020 of the augmented reality headset 2018 is then flipped by means of software associated with the headset. The user (not shown) is able to position the reflector 2014 in a manner suitable to the user.

It will be appreciated that the illustrated optics system allows a user to stand upright and keep their head upright while using the augmented reality headset.

The optics system may be provided or used in combination with an augmented reality headset, the augmented reality headset comprising one or more lenses (or a screen) through which a wearer of the headset may view the world and a camera for capturing images from the field of view of the wearer of the headset and a communication module for transmitting the captured images to a remote user.

### Further Example

A further example of an augmented reality (AR) system and method will now be described. The system and method may be used for fusing 3D mapped video obtained from two separate video streams. Any features of the further example may be combined with the first, second or third embodiments described above.

An AR headset may present a graphic layer (e.g. AR images) on a transparent monitor positioned close to the wearers eye. The graphic layer can depict various useful information and graphics that can be of benefit to the user while they are performing a task. For example, a surgeon performing surgery may use the AR headset to monitor the patient's heart rate and blood pressure without having to turn their gaze away from the surgery they are performing. The AR headset may also be used for collaboration or supervision purposes. For example, a front line worker, such as an in situ surgeon may send a video stream of a task (e.g. surgery) they are performing to a remotely located person (“remote expert” such as but not limited to a surgeon) to collaborate or supervise and provide feedback to the front line worker. In this way the remote expert may provide vocal or written feedback to the in situ surgeon. The example discussed below provides an augmented reality method and system which allows for a greater level of collaboration between two or more collaborators than can be afforded by vocal or written feedback alone.

According to one aspect of the example, there is provided a method for augmenting reality including the steps of: acquiring a first video stream from a first augmented reality headset; presenting the first video stream to a second augmented reality headset; acquiring a second video stream from the second augmented reality headset; producing a third video stream by merging the first video stream and the second video stream; and presenting the third video stream on a display of the first augmented reality headset.

The first and second video streams preferably include 3D mapped depictions of respective target subjects of each video stream. Each of the first and second video stream may be acquired by a respective array of cameras acquiring a corresponding plurality of sub-component video streams. This may include a step of fusing each of the respective plurality of sub-component video streams to produce corresponding first and second video streams.

In a some examples, the second video stream preferably depicts a pointer, the third video stream depicting the pointer interacting with content depicted in the first video stream.

In some examples, the second video stream depicts a robotic manipulator, the third video stream depicting the robotic manipulator interacting with content depicted in the first video stream.

In a some examples, the second video stream depicts one or more human hands, the third video stream depicting the one or more human hands interacting with content depicted in the first video stream.

In another aspect, there is provided an augmented reality system machine-readable code containing a set of instructions for implementing a method for augmenting reality, the method being implemented on a distributed computer system.

According to another aspect, there is provided an augmented reality system including: the system being operatively connectable to a plurality of augmented reality headsets; microprocessor-based sub-based system; an augmented reality system machine-readable code containing a set of instructions for implementing a method for augmenting reality.

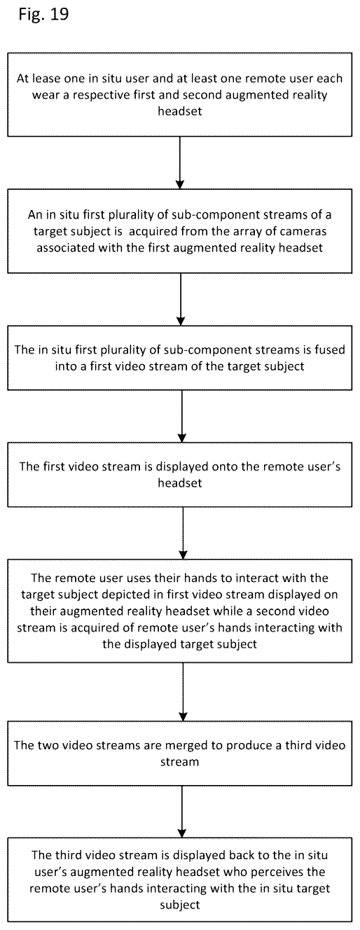

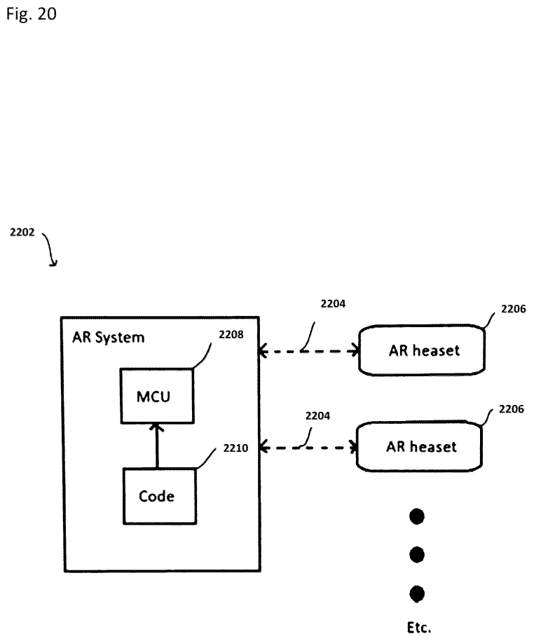

The above examples will now be described further with reference to FIG. 19, which is a flow chart of a method of augmented reality; and FIG. 20 which is a block diagram of an AR system.

Referring to FIGS. 19 and 20, the method 2100 for augmenting reality includes acquiring a first and second video stream of 3D mapped depictions of a target subject by means of a corresponding first and second reality headset. The first and second video streams are each produced by fusing respective sub-component video streams acquired from an array of cameras corresponding to each stream. The first stream is displayed on the second augmented reality headset. A third video stream is produced by merging the first and second video streams. The third video stream is displayed on the first augmented reality headset.

The second video stream may for example depict a pointer, robotic manipulator, or one or more human hands. The third video stream may for example depict one of the pointer, robotic manipulator or one or more hands interacting the content depicted in the first video stream.

In another aspect there is provided an augmented reality system machine-readable code containing a set of instructions for implementing a method for augmenting reality. The machine-readable code may be implemented on a distributed system including one or more augmented reality headsets.

In another aspect, there is provided an augmented reality (“AR”) system 2200, as shown in FIG. 20. The system 2200 is a distributed system operatively connectable 2204 to a plurality of augmented reality headsets 2206. The system includes a microprocessor-based (“MCU”) 2208 sub-system facilitating operative communication between the augmented reality headsets 2206. The system also has an augmented reality system machine-readable code 22010 containing a set of instructions for implementing a method 2201 for augmenting reality, as shown in FIG. 19.

To perform the method for augmenting reality, at least one in situ user and at least one remote user each wear a respective first and second augmented reality headset. An in situ first plurality of sub-component streams acquired from the array of cameras associated with the first augmented reality headset and is fused into a single first video stream of a target subject and displayed onto the remote user's headset. The remote user uses their hands to interact with a target subject depicted in the first video stream displayed on their augmented reality headset while a second video stream is acquired of remote user's hands interacting with the target subject, according to one preferred embodiment. The second video stream is acquired in the same manner as the first video stream. The two video streams are merged to produce a third video stream which is then displayed back to the in situ user who perceives the remote user's hands interacting with the in situ target subject.

The method for augmenting reality is performed in real-time on real-time system.

In some examples, the background portion of the third video stream is removed leaving only the hands being displayed at the location corresponding to their in situ location interacting with the target subject.

It will be appreciated that the above described augmented reality method and system allows for a greater level of collaboration between two or more collaborators.

All of the features of the various example apparatus disclosed in this specification (including any accompanying claims, abstract and drawings), and/or all of the blocks of any method or process so disclosed, may be combined in any combination, except combinations where at least some of such features and/or blocks are mutually exclusive.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method of using augmented reality (AR) to connect a remote expert with a front line worker, the method comprising:
receiving, by a processor, a first video stream from a 2D camera at a first location where the remote expert is located;
processing the first video stream in real time, by a processor, to determine 3D coordinates of a hand of the remote expert;
mapping, by a processor, an AR model to the 3D coordinates of the hand of the remote expert; and
rendering the AR model in real time as a first AR image in a AR headset at a second location at which the front line worker is located, the second location being remote from the first location.

2. The method of claim 1 wherein the mapping of the AR model to the 3D coordinates of the hand of the remote expert includes converting the 3D coordinates to the frame of reference of the front line worker.

3. The method of claim 1 further comprising capturing a second video stream of a field of view of the front line worker with a camera of the AR headset of the front line worker, inserting a second AR image corresponding to the first AR image into the second video stream and displaying the second video stream and second AR image on a display of a computing device used by the remote expert.

4. The method of claim 3 wherein inserting the second AR image in the second video stream comprises mapping the 3D coordinates of the hand of the expert to the field of view of the front line worker.

5. The method of claim 1 wherein the first AR image is a 3D representation of one of the remote expert's hands.

6. The method of claim 5 wherein the first AR image is a hologram.

7. The method of claim 1 wherein determining the 3D coordinates of the remote expert's hand includes determining coordinates of hand joints of the remote expert's hands and wherein the AR headset renders a 3D image of the remote expert's hand and hand joint movements in real time.

8. The method of claim 1 wherein the 3D coordinates comprise a point cloud generated from pixels of a 2D image of the hand captured by the 2D camera.

9. The method of claim 1 wherein a computing device of the remote expert at the first location comprises said 2D camera, a processor and a display for displaying the second video stream of the field of view of the front liner worker and the second AR image to the remote expert.

10. The method of claim 1 wherein a computing device of the remote expert sends the 3D coordinates of the remote expert's hand to the AR headset of the front liner worker and wherein the AR headset maps the AR model to the 3D coordinates of the hand of the remote expert.

11. The method of claim 1 comprising determining an orientation or pose of the AR headset of the front liner worker and converting the 3D coordinates of the hand of the remote expert to the frame of reference of the AR headset.

12. The method of claim 11 wherein converting the 3D coordinates comprises passing the 3D coordinates through an inversion matrix.

13. The method of claim 10 further comprising the AR headset sending the second video stream of the field of view of the front line worker to the computing device of the remote expert and integrating the an AR image into the second video stream.

14. (canceled)

15. (canceled)

16. A remote expert computing device comprising a display, a 2D camera and processor and a computer readable storage medium storing instructions executable by the processor to:
receive, by the processor from the 2D camera, a first video stream including a hand of the remote expert;
process the first video stream in real time to determine 3D coordinates of the hand of the remote expert; and
send the determined 3D coordinates of the hand of the remote expert to an AR headset of a front line worker.

17. The computing device of claim 16 wherein the instructions further comprise instructions to receive a second video stream of the field of view of the front line worker from a camera of the AR headset together with an AR image whose movements are based on movements of the remote expert's hand and displayed the received second video stream and AR image on the display of the remote expert computing device.

18. An AR headset comprising a screen through which a front line worker can view the real world and AR images overlaid onto the view of the real world by the AR headset; a camera for capturing a field of view of the front line worker, a processor and computer readable storage medium storing instructions executable by the processor to:
receive, in real time, 3D coordinates of a remote expert's hand;
map, in real time, an AR model to the 3D coordinates of the remote expert's hand; and
render the AR model in real time as a first AR image viewable by the wearer of the AR headset.

19. The AR headset of claim 18 wherein the instructions include instructions to convert the 3D coordinates of the remote expert's had to the frame of reference of the front line worker.

20. (canceled)

21. The AR headset of claim 18 further comprising:
a light wave emission device for projecting light onto an area in front of the AR headset to illuminate a target subject;
a communications module for receiving lighting control instructions from a remote user; and
a processor for controlling the light wave emission device in accordance with the lighting control instructions from the remote user.

22. (canceled)

23. (canceled)

24. (canceled)

25. (canceled)

26. (canceled)

27. (canceled)

28. (canceled)

29. (canceled)

30. (canceled)

31. The AR headset of claim 21, wherein the processor is configured to determine a field depth of an image captured by a camera of the AR headset by controlling a first light of the light emitting device to emit light of a first frequency to illuminate a first location on a target in front of the AR headset, control a second light of the light emitting device to emit light of a second frequency to illuminate a second location on a target in front of the AR headset, receive reflections of the first light and second lights and analyse the reflections to determine a field depth of the image.

32. (canceled)

33. The AR headset of claim 21 further comprising:
an optics device including a light guide and reflector for redirecting light from in front of and beneath the augmented reality headset into a camera of the augmented reality headset,
wherein the optics device is attached to or integral with the AR headset.

34. (canceled)

35. (canceled)

36. (canceled)

37. (canceled)

38. (canceled)

39. (canceled)

40. (canceled)

41. (canceled)
